(19) United States
(12) Patent Application Publication
(10) Pub. No.: US 2015/0154617 A1
(43) Pub. Date: Jun. 4, 2015

(54) DETERMINING LEADS BASED ON WEB SITE INTERACTIONS AND BROWSER SESSIONS

(71) Applicant: SALEMOVE, INC., New York, NY (US)

(72) Inventors: Justin DiPietro, New York, NY (US); Carlos Paniagua, New York, NY (US); Daniel Michaeli, New York, NY (US); David Rodas, New York, NY (US)

(73) Assignee: SALEMOVE, INC., New York, NY (US)

(21) Appl. No.: 14/558,815

(22) Filed: Dec. 3, 2014

Related U.S. Application Data
(60) Provisional application No. 61/911,629, filed on Dec. 4, 2013.

(51) Int. Cl. G06Q 30/02

(52) U.S. Cl. CPC G06Q 30/0201

(57) ABSTRACT

Apparatuses, computer readable mediums, and methods for determining a lead from Web site interaction. The method may include capturing one or more Web site events of a user, adding metadata to the captured Web site events, and responding to a trigger by packaging the captured Web site events and the trigger as a lead. A lead server may include a lead receiver configured to receive events with added metadata, a lead packager configured to receive an indication of a trigger, and package the received events with added metadata and the trigger into a lead, and a lead selector configured to select one or more leads from a plurality of leads for playing to an operator. The leads may be ranked in comparison with previously packaged leads.

### CROSS REFERENCE TO RELATED APPLICATION

This application claims the benefit of U.S. Provisional Patent Application No. 61/911,629, filed Dec. 4, 2013, the entire contents of which is hereby incorporated by reference as if fully set forth herein.

### TECHNICAL FIELD

The disclosed embodiments are generally directed to methods and apparatuses for determining leads from Web site interactions, and in particular, by determining leads from Web site interactions by browser session recording, storage, playback, and ranking.

### BACKGROUND

Visitors to a Web site may need assistance operating the Web site or in deciding whether to purchase goods or services. An operator may be available to help the visitor, but the operator may not know that the visitor needs help or that the visitor may make a purchase of goods or services with the operator's assistance. There may be many visitors and the operator's time may be limited, so that the operator may not be able to assist all visitors. Operators may want to spend their time helping visitors that are more likely to make a purchase or who need more help.

A business may track a contact submission form or a request information form on their Web site, but would like to know more about how the visitor interacted with the Web site content before submitting the form or request. A lead or information request with a usage recording attached may help the business better serve the customer or better evaluate which customers to serve or how to serve the customers.

There is a need in the art for an apparatus, computer readable medium, and method for determining, ranking, classifying, and delivering leads based on Web site interactions.

### SUMMARY

Some disclosed embodiments provide a method for determining leads from Web site interactions. The method may include capturing one or more Web site events of a user, adding metadata to the one or more captured Web site events, and responding to a trigger by packaging the captured Web site events and the trigger as a lead. The lead may be ranked in comparison with previously stored leads, ranking the lead by assigning a ranking indication to the lead, and classifying the lead.

A lead server may include a lead receiver configured to receive events with added metadata, a lead packager configured to receive an indication of a trigger and package received events with added metadata and the trigger into a lead, and a lead selector configured to select one or more leads from a plurality of leads for playing to an operator.

A lead server may include a lead receiver configured to receive leads, a lead selector configured to select leads from a plurality of leads, and a lead player configured to play the selected leads.

### BRIEF DESCRIPTION OF THE DRAWINGS

A more detailed understanding may be had from the following description, given by way of example in conjunction with the accompanying drawings, wherein:

FIG. 1 is an example of a lead recording and ranking system;

FIGS. 2A and 2B are an example of listening for, capturing, and sending an event;

FIG. 3 is an example of sending a lead and an event for ranking;

FIGS. 4A and 4B are an example of playing a lead;

FIG. 5 is an example of lead video playing;

FIG. 6 is an example of ranking leads;

FIG. 7 is an example of a system for determining leads from Web site interactions;

FIG. 8 is an example method of determining leads from Web site interactions; and

FIG. 9 is a simplified functional block diagram of a computer system.

### DETAILED DESCRIPTION

Lead Recording, Storage, Playback, and Ranking

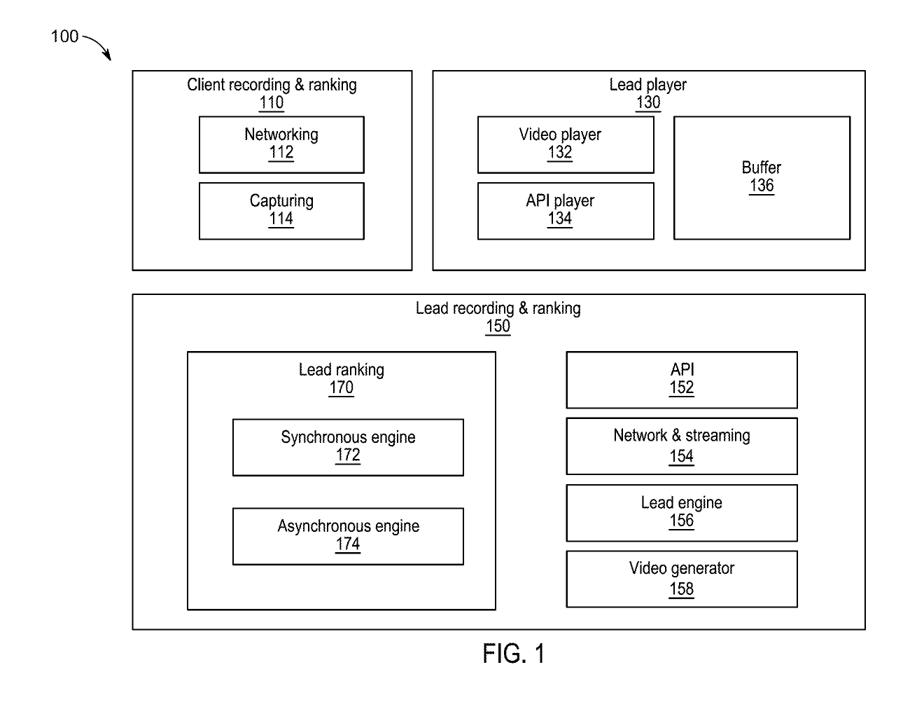

FIG. 1 is a block diagram of a Lead Recording and Ranking Architecture 100. The architecture 100 includes a client recording and ranking unit 110, a lead player unit 130, and a lead recording and ranking unit 150. The client recording and ranking unit 110 includes a networking unit 112 and a capturing unit 114. The lead player unit 130 includes a video player 132, an API player 134, and a buffer 136. The lead recording and ranking unit 150 includes an API 152, a network and streaming unit 154, a lead engine 156, a video generator 158, and a lead ranking unit 170. The lead ranking unit 170 includes a synchronous engine 172 and an asynchronous engine 174.

Lead recording represents the ability to record each individual action taken on a Web page or within an application during a usage session as the actions lead up to a particular event (“trigger”). A trigger may be a specific action taken during the usage session. Some trigger examples include: a form submission, a page view, a button click, a mouse movement, or a keystroke.

Each action in a usage session can be recorded locally or transmitted to a central server. If the actions are recorded locally, they may be sent to a central server after the trigger. The actions may also be recorded locally and sent to a central server as the actions take place. Lead recording may take place with no downloads, plugins, or extensions through the browser or any kind of application.

Lead recordings from the same user during different usage sessions may be combined. For example, a lead recording occurs with or without a trigger and subsequently a second lead recording from the same user occurs with or without a trigger, then these two lead recordings may be combined into a single lead.

Sessions may also take into account the active tab for the usage session. Each tab's presence may be recorded along with the actions taken on each tab. The active sessions from each tab may be combined to create one usage flow.

Link recordings may be sent in an email, as an attachment or link, or become viewable at a particular Web site or application destination once the trigger occurs.

The lead recording process includes three different layers: network and streaming, capture, and lead engine.

The capture layer includes client-side libraries (in one implementation, JavaScript libraries) that enable to the lead recorder to capture a user's session by listening for all the lead triggers events that cause the lead to be sent to the lead engine 156. As soon as the page starts loading, a master capturing library is loaded and it registers a listener for a standard HyperText Markup Language (HTML) event, which fired when a Document Object Model (DOM) object is fully loaded (e.g., the DocumentLoaded event). The master capturing library is notified through the DocumentLoaded event when the page is fully loaded so the capturing libraries can continue their execution. The master capture library waits until the page is fully loaded to load the rest of the capturing libraries and their dependencies. Thus, the page load time is not negatively impacted and the capturing process is transparent to the user. As soon as the capturing libraries are fully loaded along with their dependencies, the libraries register listens for DOM and user interface (UI) events so the libraries can capture all the events that occur in all the pages that belong to the same domain. The capture libraries use standard DOM mutation observers, standard DOM mutation events, custom DOM attribute events, UI events, among others, to listen for and capture any change that happens in the browser tabs under the same domain. The DOM mutation observers and DOM mutation events are referred to herein as DOM events.

A common scenario is as follows. A user loads the Web page at mycar.com. As soon as the page is loaded, the user moves a cursor over a “Show Contact Information Form” button, clicks on it, and as a result a form is dynamically generated and displayed to the user to fill out their contact information. The user completes the form and clicks on a submit button. In such a scenario, the capture libraries are loaded and run as soon as the browser fully loads mycar.com page. The capture libraries register listeners (DOM events and UI events) on all the elements in the DOM. When the user starts moving the cursor from the initial location to the “Show Contact Information Form,” each time that the cursor moves it generates an event which is handled by the capturing libraries. The capture libraries append metadata to each event prior to serializing the event and pass it to the network and streaming layer 154. By the time the user stops moving the cursor towards the “Show Contact Information Form,” the capture library already has a trace of the cursor movement along with information of which elements it passes through, the duration of the entire interaction of the user with the mouse (or other pointing device), the sequential order of the atomic “mouse move” events, among other information.

The capturing library handles several trigger events such as mouse click, mouse move, a visit to a specific page, measuring activity on the Web site, etc. For example, in the current scenario, three trigger events are registered when the capture libraries were installed: (1) when the user clicks on the “Show Contact Information Form” button; (2) when the user fills out the form (no need for the user to click the submit button); and (3) when the user has been active for more than thirty seconds.

When the user clicks on the “Show Contact Information Form,” the first lead is created. The capture libraries group all the events stored so far under the same lead recording record. This record includes information such as: loading page time, the time elapsed between the loading page and when the trigger event was fired, a detail sequence of DOM and UI events, geographical information of the user, context-aware information of the user (such as organization, public IP, network bandwidth, device, browser, operating system, contact information from Google accounts and Facebook (if accessible), among others). Historical data of the user is aggregated on the engine layer, since the capture layer only captures information in the user's browser. As soon as the trigger is fired, the capture library notifies the network layer about the event. The network layer then serializes the event data and adds metadata to the record, which is sent to the lead engine in the server.

Later, the user starts typing to complete the form. Each key pressed by the user is captured by the capturing libraries and streamed through the network layer. If the user deletes any of the keys pressed, the event is also captured. The libraries capture every time the user focuses on a form field. In the scenario described above, as soon as the email input field is filled out, the lead trigger is fired. The capturing listeners receive the trigger event and notify the network layer about the event. In contrast to the previous lead, this lead contains more information and it has different kinds of events. For example, the lead contains what characters were pressed, what characters where deleted, what was the last state of the value of the name and email input fields by the time the trigger event was fired, along with other mouse movements, JavaScript validation feedback (like an email address with an incorrect format or a phone number with an incorrect area code, where the form shows in red color the field miswritten), etc.

Further, if the user is active for 30 seconds, with interruptions no longer than 15 seconds (such criteria are configurable and the framework is flexible to adapt to different scenarios) a new trigger event is fired. The event is received by the capturing library and is passed to the network layer.

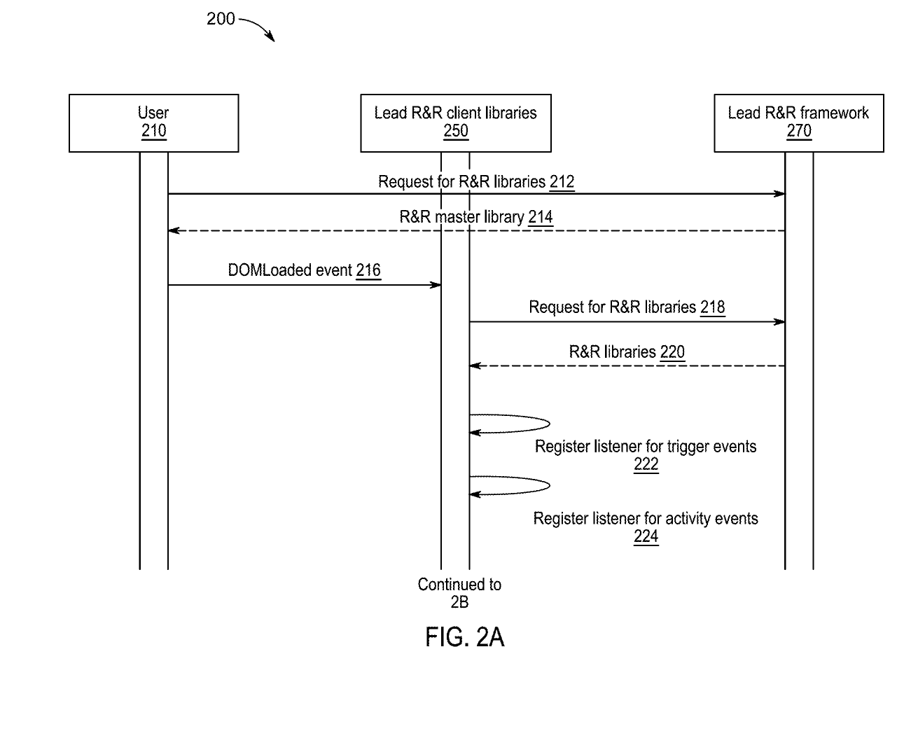

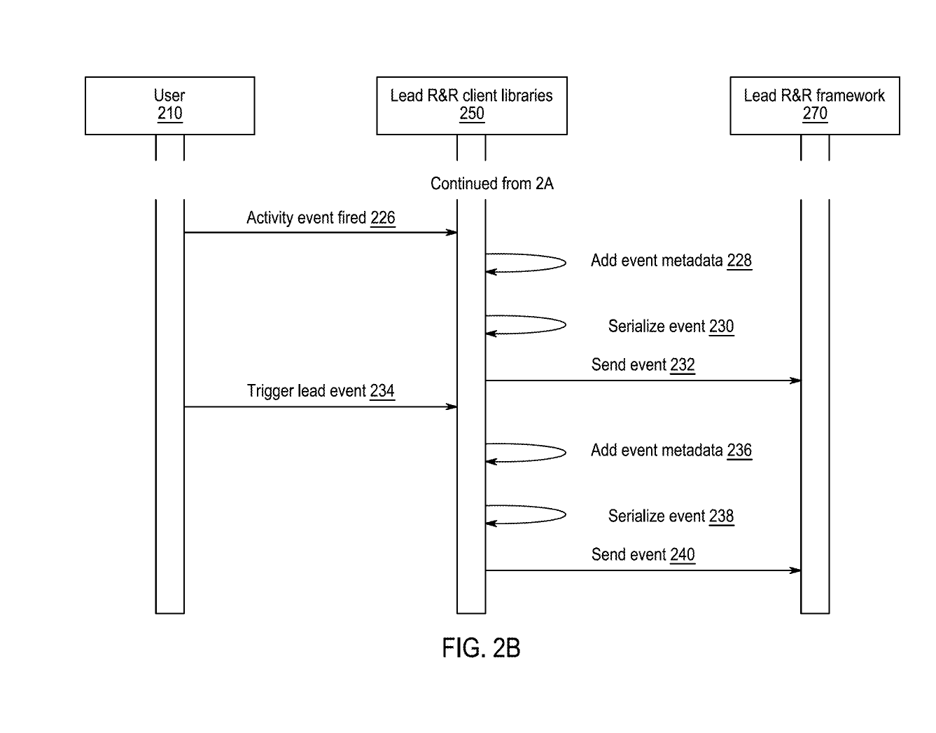

FIGS. 2A and 2B show a representative sequence for lead recording and ranking capturing. The sample lead recording and ranking capturing sequence 200 involves interactions between a user 210, lead ranking and recording (R&R) client libraries 250, and a lead R&R framework 270. First, a request for R&R libraries 212 is made by the user 210 (via the user's Web browser) to the lead R&R framework 270. An R&R master library 214 is returned to the user 210. Once the Web site has fully loaded, a DOMLoaded event 216 is transmitted from the user 210 to the lead R&R client libraries 250, which then transmits its own request for R&R libraries 218. In one implementation, the request 212 loads a bootstrapper on the user 210's device, and the request 218 is a request for the remainder of the libraries. This arrangement reduces the page loading time for the user 210.

The R&R libraries 220 are then transmitted to the lead R&R client libraries 250, which register the listener for trigger events 222 and register the listener for activity events 224. Once an activity event is fired 226 by the user 210, the lead R&R client libraries 250 add event metadata 228, serialize the event 230, and send the event 232 to the lead R&R framework 270. When a trigger lead event 234 is issued by the user 210, the lead R&R client libraries 250 add event metadata 236, serialize the event 238, and send the event 240 to the lead R&R framework 270. This continues for so long as the user 210 is browsing the Web site.

The network layer includes a client and a server. The client is installed on the user side, running in the browser, and encapsulates the logic to connect to and exchange information with the server. The client and the server can communicate using several transport protocols and mechanisms such as HyperText Transfer Protocol (HTTP), HTTP Secure (HTTPS), WebSocket (WS), secure WebSocket (WSS) over Transmission Control Protocol (TCP) or User Datagram Protocol (UDP), HTTP Polling, among others. When the client network library receives a notification from the capturing library to send information to the server, it first adds metadata to the message, like sequential event ID, timestamp, checksum, among others. Further, the network serializes the message in a Uniform Resource Locator (URL)-safe format (such as JavaScript Object Notation (JSON)) and queues it. The network library uses an asynchronous mechanism to pop elements from the events queue and stream them to the server. The library determines the best moment to send the messages, based on the network connection, network bandwidth, latency, etc. For example, if a lead needs to be sent to the server but the network connection is interrupted and the server is not reachable, the library queues the event and waits until the network connection is reestablished before sending the message to the server.

The network server side enables clients to connect to and to send/receive information to/from the server in a URL-safe serialized format. The network layer is a light high-scalable framework for exchanging information between the clients and the server. The network layer passes all the messages received to the lead engine. The lead engine receives the messages and queues them. Further, the lead engine takes the first item from the queue and deserializes it. The lead engine is responsible for grouping together a set of DOM events or UI events into a lead. Therefore, a lead is a set of sequential and sorted DOM events and UI events grouped together that describe interactions of a user with a Web site. In one implementation, the lead engine stores each event in a NoSQL database in serialized format. In one implementation, the lead engine stores metadata about the lead in a relational database. The metadata includes the user who generated the lead and information about the user and their context.

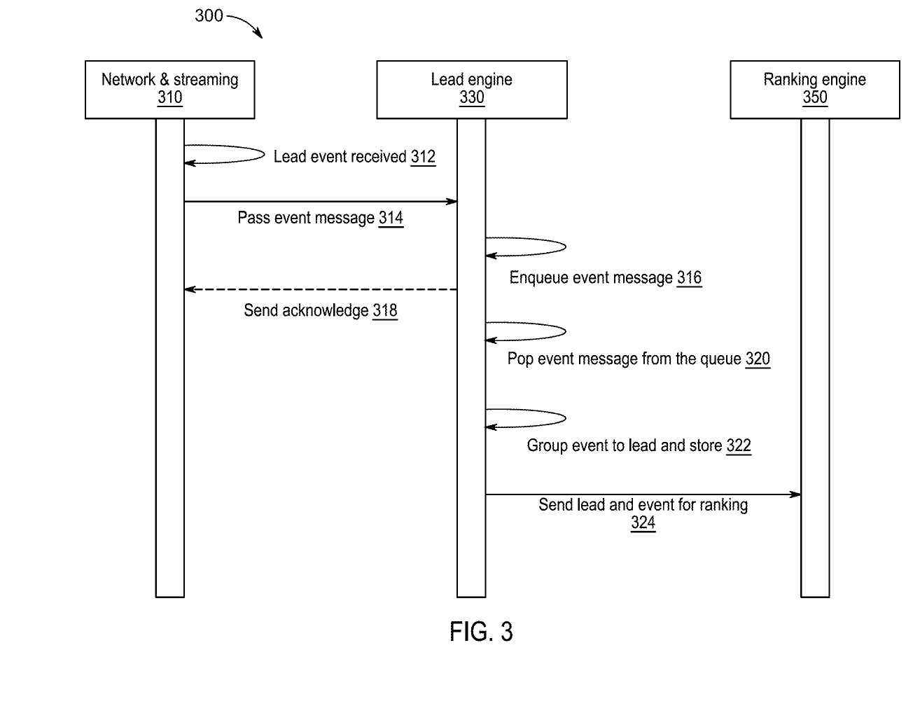

FIG. 3 discloses one embodiment of the sequence for lead recording and ranking on the server side of the system. The lead recording and ranking server side sequence 300 includes a networking and streaming component 310, a lead engine 330, and a ranking engine 350. The network and streaming 310 component waits until a lead event is received 312. Once the lead is received, the network and streaming component 310 passes the event message 314 to the lead engine 330. The lead engine 330 enqueues the event message 316 and sends and an acknowledgement 318 to the network and streaming component 310. The lead engine 330 then pops the event message from the queue 320, groups events into a lead and stores the lead 322. The lead engine 330 sends the lead and event for ranking 324 to the ranking engine 350.

Lead Playback

Lead playback refers to viewing a lead recording (as defined above). Lead playback may occur in an interface that enables the viewer to view multiple lead recordings from different Web sites or applications.

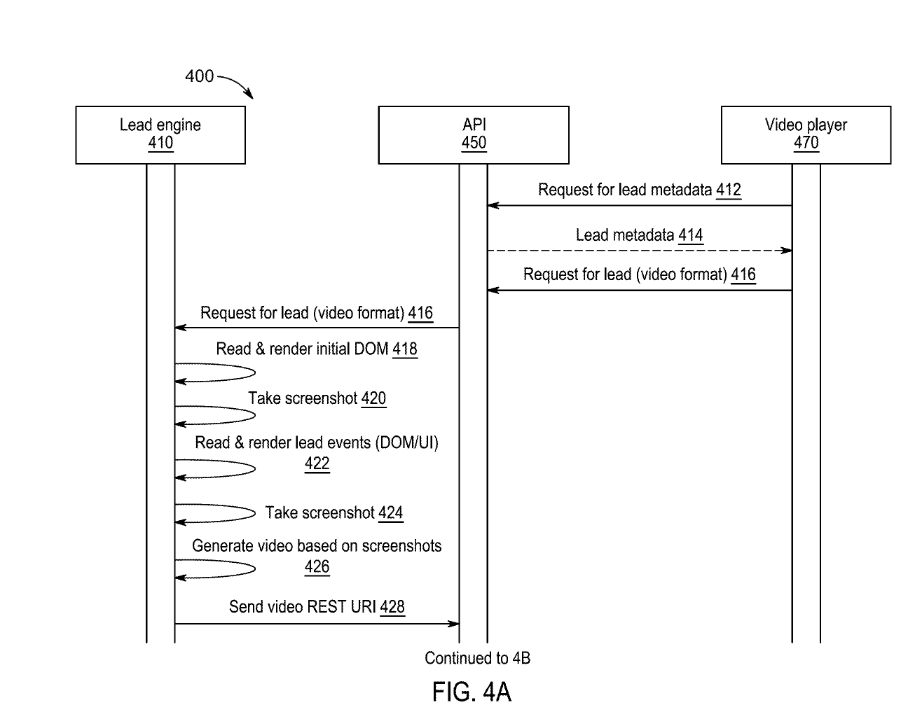

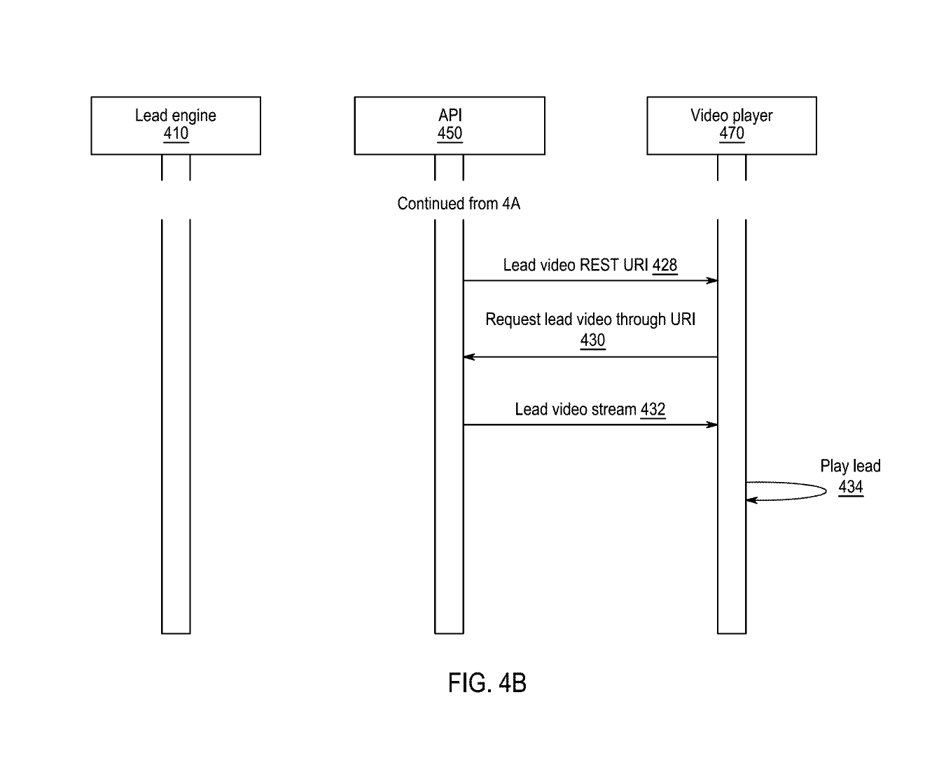

FIGS. 4A and 4B show an example sequence for playing a lead. The lead playback sequence 400 uses a lead engine 410, an API 450, and a video player 470. Initially, the video player 470 forwards a request for lead metadata 412 to the API 450. The API 450 transmits the requested lead metadata 414. The video player then issues a request for the lead in video format 416. The lead video may be generated on demand or may be preemptively generated prior to the request 416.

The request for the lead in video format 416 is passed to the lead engine 410. The lead engine 410 reads and renders the initial DOM 418. It then takes a screenshot 420, reads and renders the subsequent lead events 422, takes another screenshot 424, and generates a video based on the screenshots 426.

The lead engine 410 then sends a video Representational State Transfer (REST) Uniform Resource Identifier (URI) 428 to the API 450, which in turn passes the lead video REST URI 428 to the video player 470. The API 450 receives a request for the lead video through the URI 430 from the video player 470 and the API 450 provides the lead video stream 432 to the video player 470. Finally, the video player 470 plays the lead 434.

The lead playback speed may be altered for individual events as well as for the overall session. The lead playback speed may be adjusted by a user or automatically. The lead playback may take place in a browser or in an application.

The lead playback may display other information about the sessions, such as the user session's geographical information, system information, tabs open during the session, or other analytics about the usage session. The lead playback may also divide usage sessions into “chapters” based on a variety of criteria. For example, if a user visited the Web site or application once one day and then on another time another day (when they submitted the lead), each day or session may represent a chapter. The lead playback may have the ability to omit details for the usage session, such as an input field for credit card information.

The lead engine provides a REST API for lead manipulation. The API enables playback of a lead using a standard video player or a customized lead player. The lead engine generates a video using the stored lead sequential events. The lead engine takes the initial event of the lead, which includes a full DOM object. The lead engine renders the first event and generates a screenshot of such DOM. After the initial event containing the initial DOM is rendered, each subsequent event is retrieved from the storage layer and applied as a path to the current DOM. After each event is applied and the DOM is patched, it is rendered and a screenshot is taken again. This process repeats until all the events of the lead have been applied and a screenshot has been taken for each event. Once all the events have been read and applied, a video clip is generated using the set of screenshots by a video manipulation tool (such as ffmpeg). After the lead video is generated, it is ready to be downloaded or streamed to the client application. The video is accessible using the lead REST API.

The lead recording and ranking framework provides a lead player. The lead player accesses the REST API to read each of the sequence events of the lead. The lead player reads each event of the lead from the API and applies the lead event as a patch to the current DOM displayed by the lead player.

The lead player reads each event of the lead and applies it as a patch to the current DOM that is being shown to the user. The lead player locally saves the events so it can pull content from the API in advance, enhancing the experience for the user. In addition, locally storing the lead events enables the lead player to replay the lead at any point in time, changing the speed in which the events are being played back.

The lead engine groups together leads based on different criteria. A chapter is defined as a set of leads that share a specific criterion. The criteria are set while querying lead metadata to the REST API. A chapter criterion can be permanently stored by sending a POST Request to the API, which saves the criteria in a database in serialized format.

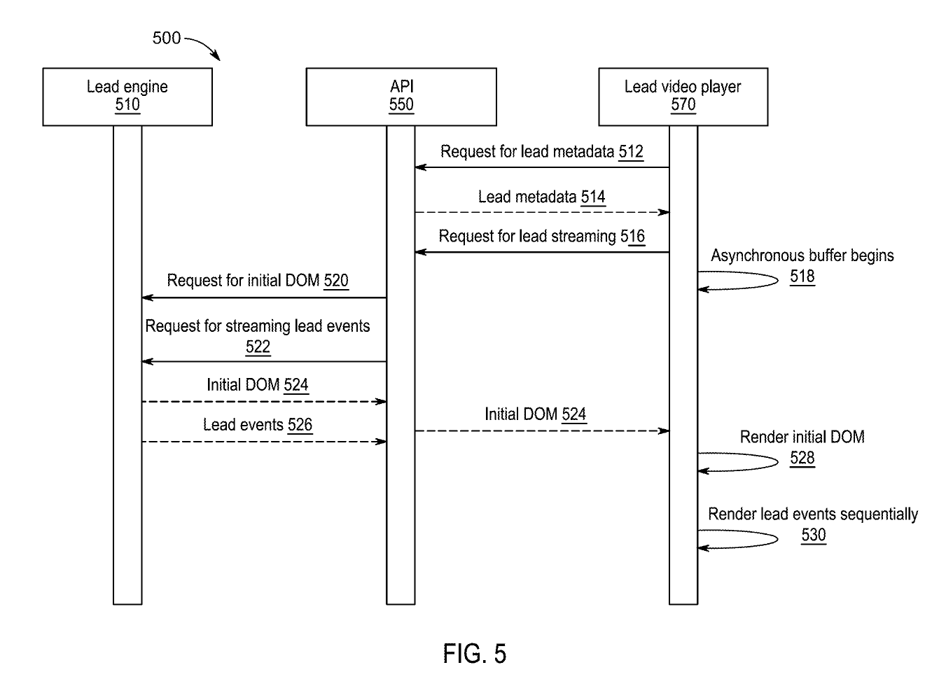

FIG. 5 shows more detail on lead playback in an alternate embodiment. The sequence for lead playback 500 involves a lead engine 510, an API 550, and a lead video player 570. The lead video player 570 issues a request for lead metadata 512 to the API 550, which provides lead metadata 514. The lead video player 570 issues a request for lead streaming 516 to the API 550. An asynchronous buffer keeps track of the lead events and their sequential order (518), which allows the video player 570 to preemptively pull the lead content or replay it afterwards.

The API 550 then issues a request for the initial DOM 520 to the lead engine 510, followed by a request for streaming lead events 522. The lead engine 510 responds with the initial DOM 524 and the lead events 526. The API 550 passes the initial DOM 524 to the lead video player 570, which then renders the initial DOM 528. The lead video player 570 then renders lead events sequentially 530.

Ranking Lead Recordings

Lead recordings may be ranked based on a number of usage session criteria, such as a propensity to purchase or a level of activity (“ranking criteria”). The ranking criteria may use machine learning, such that the rank of a particular usage session may change as more lead recordings are collected. Ranking criteria may be impacted by several factors such as purchase history, level of activity, previous or future appointment data, among others.

Factors that influence the ranking criteria may be uploaded during the usage session, after the usage session, or integrated via a direct data feed such as an API. If the data includes sensitive information, such as a credit card number or a social security number, it can be encrypted and sent using secure network transmission channels, such as HTTPS/Secure Sockets Layer (SSL) or WSS to the API server. Lead recordings that have been ranked according to the ranking criteria may be sold for a price that relates directly to the lead ranking.

An example of lead ranking used in a business context could be selling the lead recordings to car dealerships based on the ranking criteria, that the usage session represents a consumer that is in market for a vehicle. The dealership could use lead playback to view a highly ranked usage session and tailor the subsequent sale to that customer based on the lead playback.

The lead recording and ranking framework includes a ranking engine. The ranking engine operates in two modes: real-time ranking (including real-time and soft real-time scales) and asynchronous ranking. The asynchronous ranking takes place with every event received by the lead engine that is not a trigger event.

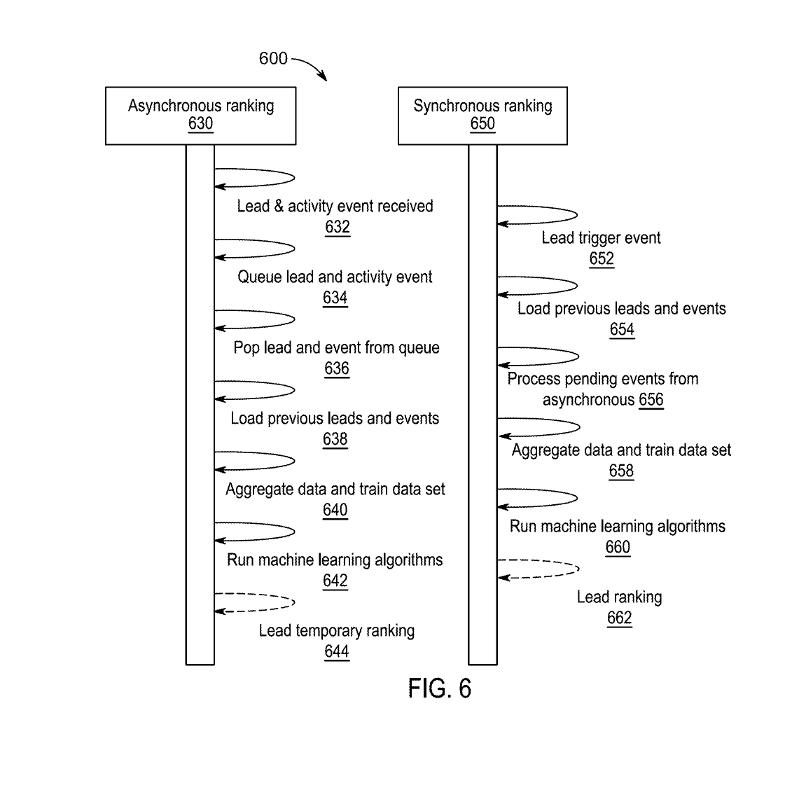

Examples of the processes for ranking leads by the ranking engine are shown in FIG. 6. The asynchronous ranking 630 starts when a lead and activity event is received 632, and the lead and activity event is queued 634. The lead and activity event is then popped from the queue 636, previous leads and events are loaded 638, and the data is aggregated and a training data set is created 640. Machine learning algorithms are run 642, and a temporary lead ranking 644 is generated.

The synchronous ranking 650 starts when a lead trigger event 652 is received, which prompts the loading of previous leads and events 654. Pending events from the asynchronous ranking are processed 656. The data is aggregated and a training data set is created 658. Machine learning algorithms are run 660, and a lead ranking 662 is generated.

By way of further explanation, when an event is received, it is saved and processed by the lead engine. When the lead engine completes the saving and grouping process of the lead events, the lead engine passes the message to the ranking engine. The ranking engine receives the lead and the lead event. The lead includes information about the user and their context. The ranking engine reads the leads generated by the user and the events corresponding to those leads. The ranking engine takes as inputs the leads, the lead events for each lead, and the user's information, to apply machine learning algorithms such as decision trees, association rules, artificial neural networks, inductive logic programming, vector machines, clustering, Bayesian networks, reinforcement, representation, similarity and metrics, or sparse dictionary, among others.

The aim of such processing is to discover and create relationships, dependencies among the lead event data, lead events, user information, and user context. The result of the machine learning process can be used to rank the quality of the leads, predict interests (preferences in terms of taste and/or emotions), and likeliness of different actions to happen, such as purchasing. The data set that is used as input for the machine learning process, via the asynchronous ranking, is restructured and updated to find relationships among the data every time that a new event is added to the set.

The process happens asynchronously since the engine finds the best time to process the data set on demand. For instance, two leads, A and B, need to be ranked. But lead A needs to be delivered before lead B, even though lead B is constantly adding events to its set. Lead B waits until lead A is fully processed. Therefore, lead A is ranked before lead B, and lead B will be processed after lead A. The ranking engine includes a prioritization mechanism to process the leads on demand. The ranking engine can decide how to process the leads based on data availability. For example, the data of lead A is available right away, while the data of lead B needs to be retrieved from another server or source. In this scenario, lead A is processed, while the data from lead B is delivered to the ranking engine. The ranking engine can decide the order in which the leads are processed based on request/demand, availability of data, and resources such as bandwidth, processing, etc.

The real-time ranking process occurs when a trigger event is fired. The trigger event means that the lead is complete and needs to be delivered to the interested parties. When the lead engine finishes processing the trigger event, it is passed to the ranking engine. The ranking engine then assigns a high priority to the lead so it can be processed before other leads in the queue. The ranking engine repeats the machine learning process described above and delivers the lead along with the relationships discovered from the lead's data set (lead events, user information and context, etc.). When a lead is retrieved from the REST API, it might include the lead data events to be replayed plus the discovered relationships discovered by the ranking engine.

Lead Delivery

Lead recordings may be transmitted using a lead delivery system that packages and sends the lead recordings. Lead delivery may include packaging lead recordings with additional information to provide context or value. This additional information may include an in-depth analysis of the lead, details on the ranking criteria, individualized sales/talking points for the lead recording, or other useful information.

An example of lead delivery used in a business context includes packaging and sending lead recordings to car dealership with information for the lead recording that may facilitate the sale of the vehicle, such as stating that the consumer has been looking for an SUV for over a month and likes the color green.

The recording and ranking framework includes a delivery engine. The delivery engine is a scheduler which can be configured to deliver leads based on a combination of different criteria such as time-based, client-based, lead ranking (only leads which satisfied specific ranking criteria), among others. The delivery engine delivers leads in real-time on demand or asynchronously in batches. The delivery engine can be configured to send leads which match specific criteria in real-time. For example, the delivery engine can be configured to send a lead immediately if the lead has a set of relationships describing a user who has been in the same page several times, has spoken with a sales representative, and has filled out the necessary documents to complete the purchase. The lead is highly ranked and needs to be delivered as soon as possible to the dealership.

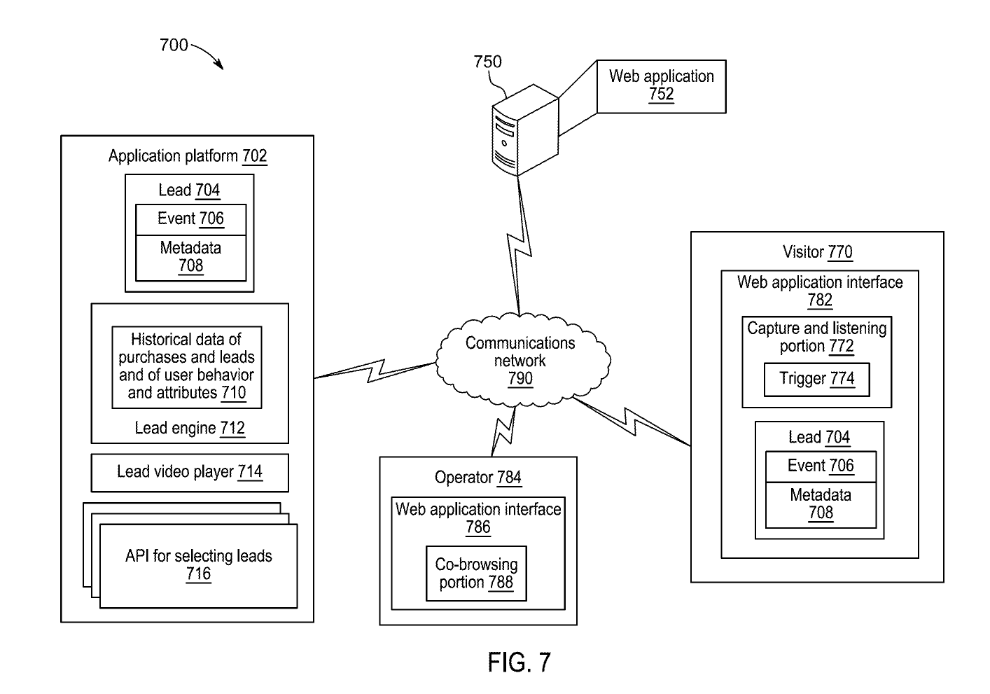

FIG. 7 schematically illustrates a system for determining leads from Web site interaction. The system 700 includes an application platform 702, a Web server 750, a visitor 770 (referred to above as the user), an operator 784, and a communications network 790. The Web server 750 includes a Web application 752 that operates while the visitor 770 consumes content from the Web application 752. When the visitor 770 accesses the Web application 752, a Web application interface 782 is provided to the visitor 770. The Web application interface 782 includes a capture and listening portion 772 which waits for a pre-determined trigger 774 from the visitor 770. Once the trigger 774 is received, the Web application interface 782 generates a lead 704, including event data 706 and metadata 708 obtained from the visitor 770. The lead 704 (including the event data 706 and the metadata 708) is then transmitted to the application platform 702 via the communications network 790.

The application platform 702 receives the lead 704. The lead 704 is then processed by a lead engine 712, which aggregates, ranks, and stores the lead to provide historical data 710 for visitors 770 to the Web application 752. The historical data 710 includes purchases, leads, past user behavior, and attributes of the visitor 770. A lead video player 714, also part of the application platform 702, can provide video playback of leads 704 which are stored by the lead engine 712. An API for selecting leads 716 is part of the application platform 702 and is used to quickly locate and use valuable leads by the operator 784.

The operator 784 uses a Web application interface 786 which includes a co-browsing portion 788 to facilitate contact initiation with the visitor 770 in response to the visitor's actions on the Web application 752. The Web application interface 782 can be used to access data on the application platform 702 for this purpose.

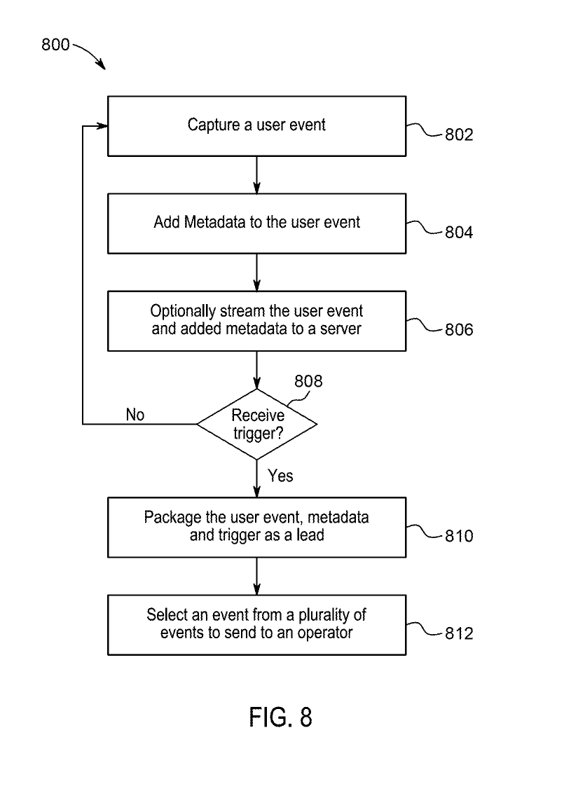

FIG. 8 shows a sample method of determining leads from Web site interaction using the system described in FIG. 7. The method 800 begins by capturing a user event (step 802). Metadata is added to the user event (step 804) and the user event and the added metadata are optionally transmitted to a server (step 806). A determination is made whether a trigger is received (step 808). If a trigger has not been received, the method 800 continues, with capturing another user event (step 802). Once a trigger is received (step 808), the user event, metadata, and trigger are packaged as a lead (step 810). An event is selected from a plurality of events and is sent to an operator (step 812).

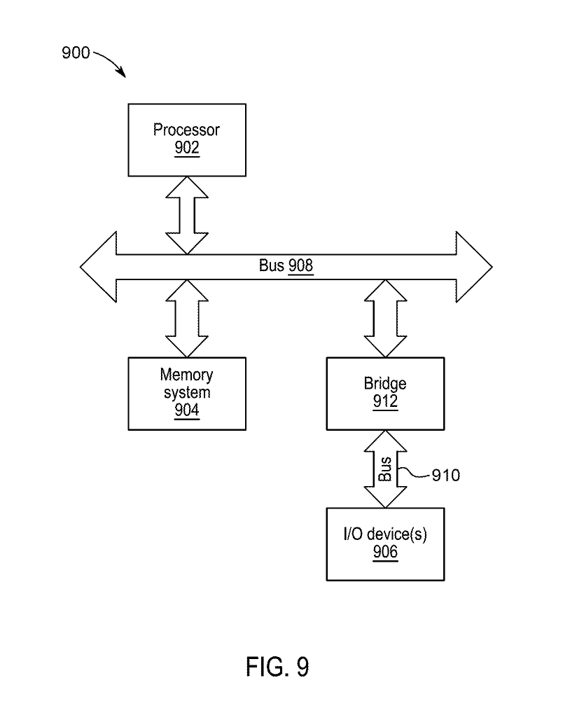

FIG. 9 is a simplified functional block diagram of a computer system 900. One or more of the operator, application platform, Web server, Web application, and other systems described herein may be implemented by the computer system 900, where portions of the co-browsing server, visitor, operator, application platform, Web server, Web application, and other systems may be implemented in software, hardware, or firmware. In some embodiments, the functions implemented may be distributed across multiple computer systems 900.

As illustrated in FIG. 9, the computer system 900 includes one or more processors 902, one or more memory systems 904, and one or more input/output (I/O) devices 906 in communication by two communication buses 908, 910, and a bridge 912. The communication buses 908, 910 and bridge 912 may be implemented in a variety of ways and may include one or more computer buses 908, 910 and/or bridge devices 912 as shown in FIG. 9. The I/O devices 906 can include network adapters and/or mass storage devices from which the computer system 900 can receive data from one or more of the co-browsing server, visitor, operator, application platform, Web server, Web application, and other systems described herein for processing by the processor 902 when the computer system 900 operates as one or more of the co-browsing server, visitor, operator, application platform, Web server, Web application, and other system described herein.

The methods and apparatuses provided may be implemented in a general purpose computer, a processor, or a processor core. Suitable processors include, by way of example, a general purpose processor, a graphics processing unit (GPU), a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a non-transitory computer-readable media). The results of such processing may be maskworks that are then used in a semiconductor manufacturing process to manufacture a processor which implements aspects of the disclosed embodiments.

The methods or flow charts provided herein may be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for determining a lead from a Web site interaction, comprising:
capturing one or more Web site events of a user;
adding metadata to the one or more captured Web site events; and
in response to a trigger, packaging the captured Web site events and the trigger as a lead.

2. The method of claim 1, further comprising:
storing a plurality of leads; and
selecting one or more leads from the plurality of leads based on a search criteria.

3. The method of claim 2, further comprising:
playing back the browsing session for the selected one or more leads to an operator.

4. The method of claim 2, wherein:
the search criteria includes at least one of: a previous behavior of the user, a previous user behavior prior to making a purchase, a set of user interactions, or an attribute of the user, and
the attribute is at least one of: a salary of the user or a readiness to make a purchase.

5. The method of claim 1, further comprising:
determining whether the lead meets a search criteria; and
if the lead meets the search criteria, sending the lead to an operator.

6. The method of claim 1, wherein the event is at least one of: a document object model event or user interface event.

7. The method of claim 1, wherein the trigger is at least one of: a mouse click, a page view, a completion of a form, a page view for a period of time, a combination of a first page view followed by a second page view, or a set of interactions.

8. The method of claim 1, wherein the metadata is at least one of: the user associated with the event or a time since a previous event.

9. The method of claim 1, further comprising:
ranking the lead in comparison with a plurality of previously stored leads.

10. The method of claim 1, further comprising:
ranking the lead to give an indication of a rank of the lead.

11. The method of claim 10, wherein the rank of the lead is a numeric value to indicate a value of the lead.

12. The method of claim 1, further comprising:
classifying the lead into one or more classifications.

13. A computer server for processing a lead from a Web site interaction, comprising:
a lead receiver, configured to receive a lead, wherein a lead includes one or more Web site events of a user, metadata associated with the one or more Web site events, and a trigger;
a lead selector, configured to select a lead from a plurality of stored leads; and
a lead player, configured to play the selected lead.

14. The computer server of claim 13, wherein:
the lead selector is configured to select one or more leads from the plurality of leads based on a search criteria;
the search criteria includes at least one of: a previous behavior of the user, a previous user behavior prior to making a purchase, a set of user interactions, or an attribute of the user, and
the attribute is at least one of: a salary of the user or a readiness to make a purchase.

15. The computer server of claim 13, wherein the lead player is configured to play back the user's Web browsing session for the selected lead to an operator.

16. The computer server of claim 13, further comprising:
a ranking engine, configured to rank the lead in comparison with a plurality of previously stored leads.

17. The computer server of claim 16, wherein the rank of the lead is a numeric value to indicate a value of the lead.

18. The computer server of claim 16, wherein the ranking engine is further configured to classify the lead into one or more classifications.
